(19) United States
(12) Patent Application Publication
(10) Pub. No.: US 2026/0210987 A1
(43) Pub. Date: Jul. 23, 2026

(54) DEVICE FOR FLUID DISPENSING

(71) Applicant: ClickBio, Inc., Reno, NV (US)

(72) Inventors: Justin FERRANTO, Reno, NV (US); Jonathan SHOPES, Reno, NV (US)

(73) Assignee: ClickBio, Inc., Reno, NV (US)

(21) Appl. No.: 19/457,943

(22) Filed: Jan. 23, 2026

Related U.S. Application Data
(60) Provisional application No. 63/748,565, filed on Jan. 23, 2025.

(51) Int. Cl. G01N 35/10; G01N 35/00

(52) U.S. Cl. CPC G01N 35/10; G01N 35/0099

(57) ABSTRACT

An automated fluid dispensing system includes a computing device, a fluid dispensing device, and a robotic arm. The fluid dispensing device includes tubing configured to make contact with a fluid running from a fluid inlet to a fluid outlet, and a pump assembly configured to pump the fluid from the fluid inlet to the fluid outlet without making contact with the fluid. The pump assembly includes a pump and a rotational stepper motor configured to provide power to the pump. The robotic arm directs the fluid out of the fluid outlet and into fluid well(s) based on a respective position of each fluid well. The computing device provides command(s) to the fluid dispensing device and robotic arm. A dispensing volume of the fluid dispensing device corresponds to a 360-degree rotation of the pump divided by its number of rollers.

### CROSS-REFERENCE TO RELATED APPLICATION

This application claims priority under 35 U.S.C. § 119 to U.S. Provisional Patent Application No. 63/748,565, filed Jan. 23, 2025, entitled “DEVICE FOR FLUID DISPENSING,” the entire contents of which are fully incorporated herein by reference as if fully set forth below.

### FIELD

The presently disclosed subject matter generally relates to fluid dispensing devices.

### BACKGROUND

Fluid dispensing devices are typically used for handling and dispensing of cell culture media or other reagents into various vessels, such as microplates, flasks, test tubes, and the like. Often times, these dispensing devices are used in laboratory settings for conducting various procedures or experiments involving one or more fluids. Existing liquid dispensing devices, however, present a variety of challenges.

First, existing on-demand fluid dispensing stations cannot be used with larger volume plates designed for large throughput applications. In order to fill these plates, lab automaters would have to fill large volume plates by manual pipette, which is costly and prone to human error. This would also create a human interference step in a workflow which would have prevented the workflow from being fully automated.

Additionally, there is a notable lack of devices capable of dispensing large volumes of cell culture media or other reagents efficiently and quickly. The majority of automated liquid handling systems use disposable pipette tips with an air displacement mechanism. While this set up helps increase accuracy and limit the risk of cross contamination, it also compromises the speed at which reagents can be dispensed. Dispensing speed is a crucial factor in lab automation especially for high throughput or time-sensitive applications, such as those involving suspended beads. Delays in dispensing can lead to beads settling at the bottom of wells, potentially compromising experimental results. The speed of dispensed reagents can be a bottleneck for other processes downstream. This bottleneck may decrease throughput and increase cost.

Further, automated dispensers that do not rely on air displacement must have some other pumping mechanism to move the liquid. Most mechanical pumps such as centrifugal or impeller style pumps must come into contact with the liquid being pumped. This greatly increases the risk of cross contamination and requires frequent and time consuming disassembly, cleaning and sterilization to mitigate such risk. Furthermore, cleaning or sterilizing these components might not be feasible due to complex shapes, incompatibility with cleaning or sterilizing agents, and/or incompatibility with sterilization techniques, such as autoclaving or irradiation.

Additionally, syringe pumps offer a combination of accuracy and a disposable fluid path, however, are often very slow due to reduced cross section area at the nozzle and the requirement that liquid be drawn into the syringe before it can be pumped. Furthermore, a syringe pump set up for continuous use must include an array of automated valves. In many cases these valves can introduce a risk of contamination.

Further, filling large volume tubes with reagents is a process that is typically done with a manual pipette. This approach requires a human operator to be present in the lab around the clock to maintain continuous throughput for high demand workflows. Such a requirement is not only impractical, but it incurs significant cost. Additionally, the manual nature of this task increases the likelihood of human error, such as pipetting inaccuracies, cross-contamination, or missed samples. These mistakes can compromise the integrity of experiments, leading to wasted resources and the need to repeat critical steps. The repetitive and monotonous nature of manual pipetting also contributes to operator fatigue, further exacerbating the risk of errors over extended periods.

Moreover, relying on manual processes limits scalability, as the number of tubes that can be filled is directly constrained by the physical capacity and endurance of the operator. This inefficiency becomes a significant bottleneck in workflows requiring large-scale reagent dispensing, delaying downstream processes and increasing the overall time to complete experiments. These limitations underscore the urgent need for automated solutions capable of handling large-volume dispensing tasks efficiently and accurately, eliminating the reliance on continuous human involvement.

Another limitation of existing dispensers is their inability to fill multiple wells simultaneously, as dispensers on the market are typically designed to handle only one well at a time. This constraint significantly hampers efficiency in high-throughput workflows, where processing numerous plates in quick succession is essential. The need to refill or reposition plates manually between dispensing cycles introduces additional downtime and disrupts the continuity of the process. For laboratories managing large-scale experiments, this single-plate limitation leads to prolonged processing times, reduced productivity, and increased labor costs. In automated workflows, this inefficiency can cascade into delays for subsequent steps, further compounding bottlenecks which can compromise the overall speed and scalability of an operation.

Accordingly, there is a need for fluid dispensing devices. Embodiments of the present disclosure are directed to these and other considerations.

### SUMMARY

Briefly described, embodiments of the presently disclosed subject matter relate to fluid dispensing devices.

In an aspect, an automated fluid dispensing system is disclosed. The automated fluid dispensing system includes a computing device having one or more processors, and a memory. The automated fluid dispensing system further includes a first fluid dispensing device having first tubing including a first fluid inlet and a first fluid outlet. The first tubing makes contact with a first fluid running from the first fluid inlet to the first fluid outlet. The first fluid dispensing device also includes a first pump assembly configured to pump the first fluid from the first fluid inlet to the first fluid outlet without making contact with the first fluid. The first pump assembly includes a first pump having a rotor and a number of rollers attached to the rotor, and a first rotational stepper motor configured to provide power to the first pump. The automated fluid dispensing system further includes a robotic arm configured to direct the first fluid out of the first fluid outlet and into one or more fluid wells based on a respective position of each fluid well. The computing device provides one or more commands to the first fluid dispensing device and the robotic arm. A dispensing volume of the first fluid dispensing device corresponds to a 360-degree rotation of the first pump divided by the number of rollers.

In another aspect, an automated fluid dispensing system is disclosed. The automated fluid dispensing system includes a computing device having one or more processors, and a memory. The automated fluid dispensing system further includes a first fluid dispensing device having first tubing including a first fluid inlet and a first fluid outlet. The first tubing makes contact with a first fluid running from the first fluid inlet to the first fluid outlet. The first fluid dispensing device also includes a first pump assembly configured to pump the first fluid from the first fluid inlet to the first fluid outlet. The first pump assembly includes a first peristaltic pump, and a first rotational stepper motor configured to provide power to the first peristaltic pump. The automated fluid dispensing system further includes a robotic arm configured to direct the first fluid out of the first fluid outlet and into one or more fluid wells based on a respective position of each fluid well. The computing device provides one or more commands to the first fluid dispensing device and the robotic arm. The first fluid dispensing device provides at least approximately 200 microliters (μL) of displaced fluid through the first tubing for each quarter rotation of the first peristaltic pump.

In another aspect, an automated fluid dispensing system is disclosed. The automated fluid dispensing system includes a computing device having one or more processors, and a memory. The automated fluid dispensing system further includes a first fluid dispensing device having first tubing including a first fluid inlet and a first fluid outlet. The first tubing makes contact with a first fluid running from the first fluid inlet to the first fluid outlet. The first fluid dispensing device also includes a first pump assembly configured to pump the first fluid from the first fluid inlet to the first fluid outlet without making contact with the first fluid. The first pump assembly includes a first pump, and a first rotational stepper motor configured to provide power to the first pump. The automated fluid dispensing system further includes a second fluid dispensing device having second tubing including a second fluid inlet and a second fluid outlet. The second tubing makes contact with a second fluid running from the second fluid inlet to the second fluid outlet. The second fluid dispensing device also includes a second pump assembly configured to pump the second fluid from the second fluid inlet to the second fluid outlet without making contact with the second fluid. The second pump assembly includes a second pump, and a second rotational stepper motor configured to provide power to the second pump. The automated fluid dispensing system further includes a robotic arm configured to direct (i) the first fluid out of the first fluid outlet and into one or more first fluid wells based on a first respective position of each first fluid well, and (ii) the second fluid out of the second fluid outlet and into one or more second fluid wells based on a second respective position of each second fluid well. The computing device provides one or more commands to the first pump assembly, the second pump assembly, and the robotic arm. The automated fluid dispensing system provides at least approximately 200 microliters (μL) of displaced fluid through the first tubing for each quarter rotation of the first pump, and provides at least approximately 200 microliters (μL) of displaced fluid through the second tubing for each quarter rotation of the second pump.

The foregoing exemplifies certain aspects of the presently disclosed subject matter and is not intended to be reflective of the full scope of the presently disclosed subject matter. Additional features and advantages of the presently disclosed subject matter are set forth in the following exemplary description, may be apparent from the description, or may be learned by practicing the presently disclosed subject matter.

### BRIEF DESCRIPTION OF THE DRAWINGS

FIG. 1 is an example automated fluid dispensing system, according to exemplary embodiments.

FIG. 2 is an example computing device of the automated fluid dispensing system of FIG. 1, according to exemplary embodiments.

FIGS. 3A-3E provide perspective (A), side (B), top (C), front (D), and side cross-section (E) views of an example pump assembly of the automated fluid dispensing system of FIG. 1, according to exemplary embodiments.

FIG. 4 illustrates components of the automated fluid dispensing system of FIG. 1, according to exemplary embodiments.

### DETAILED DESCRIPTION

To facilitate an understanding of the principles and features of the disclosed technology, illustrative embodiments are explained below. The components described hereinafter as making up various elements of the disclosed technology are intended to be illustrative and not restrictive.

The disclosed fluid dispensing devices aim to overcome the challenges found with current dispensing devices. For example, the disclosed fluid dispensing devices allow for large-volume liquid dispensing by enabling quick and precise filling of multiple wells in a plate, reservoir, tube or other receptacle, addressing a critical need in high-throughput applications. Using a rotational stepper motor, the volumetric amount of liquid that is dispensed can be efficiently controlled in accurate amounts, allowing for precise large volume dispensing. The advantage of a rotational stepper motor over a brushed DC motor, for example, is the rotational distance and speed can be efficiently controlled with a corresponding stepper driver. This allows for more precision as each quarter of a rotation corresponds to approximately 200 microliters (μL) of displaced fluid through the tubing by the peristaltic pump.

The disclosed devices can operate both on and off liquid handling decks, significantly accelerating workflows and enhancing adaptability to various laboratory setups. This is due to the use of a robotic arm (e.g., a Selective Compliance Assembly Robot Art (SCARA)) working in tandem with a pump (e.g., peristaltic pump) module. The robotic arm allows the fluid to be dispensed over different X and Y coordinates (horizontal, or side to side) which can correspond to different well or tube positions. The Z height (vertical) can also be lowered into the well or tube to reduce the risk of cross contamination of samples. For a benchtop application, the robotic arm can be paired with a plate position and priming reservoir (e.g., SBS) to accurately determine the position of the plate that is being filled. For applications on the liquid handling deck, the robot arm can be paired with a waste reservoir and platform inside the liquid handler for coordinating X and Y positions. Its ability to dispense large volumes accurately ensures consistent and reliable results, reducing errors and improving experimental outcomes.

A key feature of the disclosed dispensing devices are their disposable fluid paths, which minimizes cross-contamination risks and simplifies maintenance. This is done through the use of a pump module (e.g., a peristaltic pump module) which displaces fluid through a compliant tube (e.g., platinum cured silicone) with rotational movement. This attribute makes it especially suitable for applications requiring high sterility or involving multiple reagents. The pump module and robotic arm can accept serial commands from a computer or script (e.g., through a Universal Serial Bus (USB) port) which allows the dispensing device to integrate seamlessly into larger automated workflows, enhancing its utility as a versatile component in complex laboratory processes.

By automating the dispensing of large volumes, the disclosed devices eliminate the need for manual pipetting, solving the inefficiency and human error associated with filling large amounts of cell culture media by hand. The disclosed devices also address the challenge of magnetic beads or cells settling at the bottom of reservoirs by allowing on demand delivery of the beads. This means that the beads or cells spend most of their time in a large agitated off-deck reservoir, and once dispensed, don't have the time to settle before being used. This ensures that beads are accessible for experiments without compromising their integrity.

Furthermore, the disclosed dispensers overcome the limitation of traditional dispensers by allowing the filling of multiple reagents with the same platform. streamlining operations and reducing the need for multiple specialized devices. This is done by adding additional pump modules to the same robotic arm. This innovation not only boosts throughput and accuracy, but also provides a scalable, user-friendly solution for modern laboratory environments.

Reference will now be made in detail to example embodiments of the disclosed technology that are illustrated in the accompanying drawings and disclosed herein. Wherever convenient, the same reference numbers will be used throughout the drawings to refer to the same or like parts.

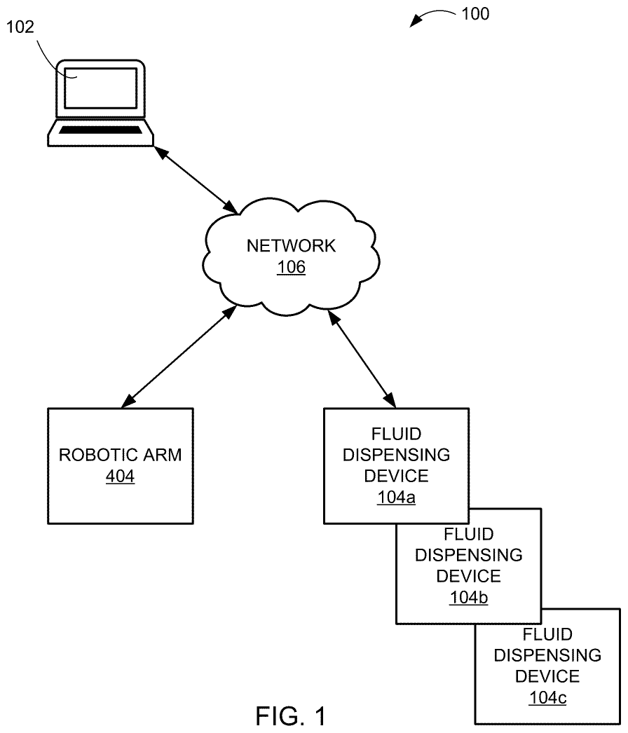

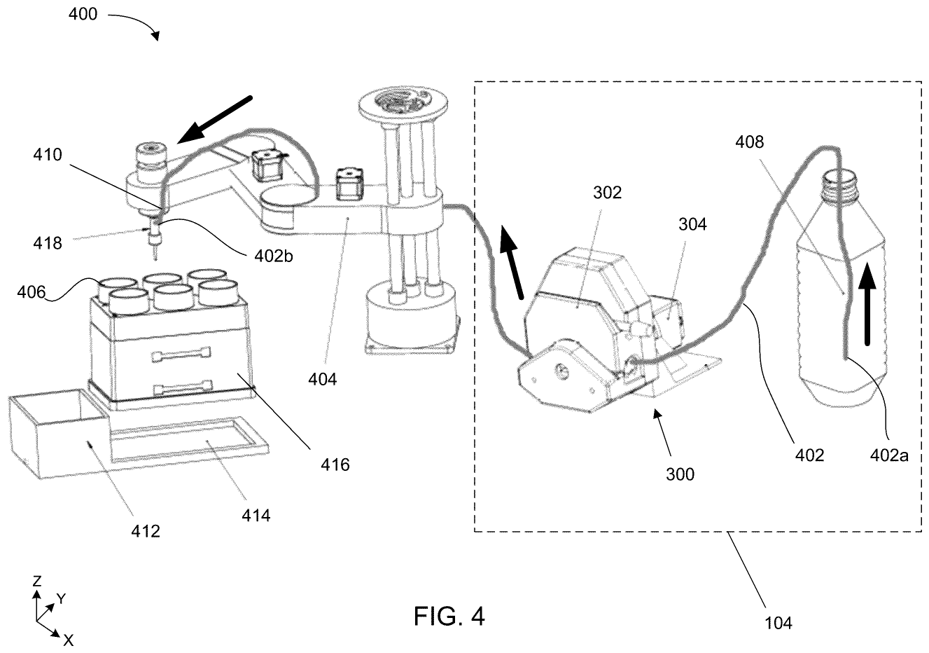

FIG. 1 provides a schematic of an automated fluid dispensing system 100 having a computing device 102 that communicates with one or more fluid dispensing devices 104 (e.g., 104a, 104b, 104c) and a robotic arm 404 via a network 106. As further discussed below with respect to FIG. 4, each fluid dispensing device 104 can include a pump assembly 300, a fluid source reservoir 408, and tubing 402 configured to contact a respective fluid. As discussed herein, multiple fluid dispensing devices 104 can be connected to a single computing device 102 and a single robotic arm 404. The computing device 102 provides commands to the fluid dispensing devices 104 as well as the robotic arm 404, for example, to cause the robotic arm 404 to transition between the multiple fluid dispensing devices 104 to dispense their respective fluids into fluid wells.

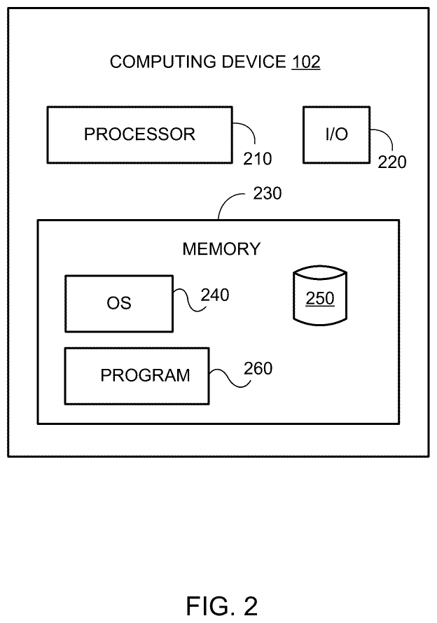

As particularly shown in FIG. 2, the computing device 102 can include one or more processors 210, an input/output device 220, and a memory 230 that itself can include an operating system (“OS”) 240, a database 250, and a program 260. As discussed further below, the computing device 102 can issue one or more commands to the fluid dispensing device(s) 104 and the robotic arm 404.

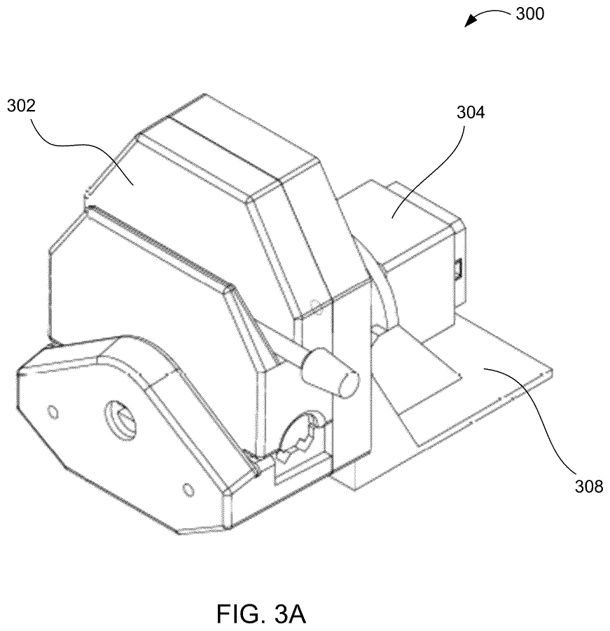

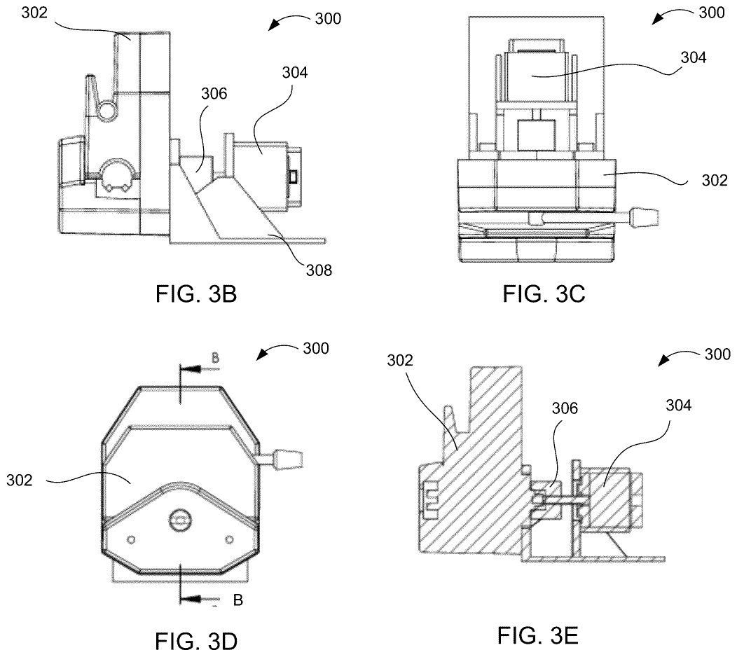

FIGS. 3A-3E provide schematics of a pump assembly 300 that can be incorporated into a fluid dispensing device 104. FIG. 3A provides a perspective view of the pump assembly 300, that can include a pump 302 and a motor 304 for powering the pump 302. FIGS. 3B-3E respectively provide side (3B), top (3C), front (3D), and side cross-sectional (3E) views of the pump assembly 300. The pump 302 can be a positive displacement pump, a centrifugal pump, an axial-flow pump, and/or a peristaltic pump. In some embodiments, the pump does not come in contact with the handled fluid. The motor 304 can be a rotational stepper motor. The pump 302 and motor 304 can be removably attached to one another via a coupling 306. In some embodiments, the pump assembly 300 can further include one or more pump heads, a motor base 308, a microcontroller (e.g., Arduino®), a CNC shield, an input/output device (e.g., a keypad, display screen (e.g., LCD), etc.), and/or a motor controller (e.g., stepper motor driver) configured to control a rotational distance and/or a speed of the motor 304. The pump and stepper motor combination can be calibrated to accurately dispense controlled volumes of fluid into wells of a microplate, test tube, flask, reservoir, or other types of liquid vessels, as further discussed below.

FIG. 4 provides a diagram of an example fluid dispensing system 400 including a fluid dispensing device 104 and a robotic arm 404. As shown, the fluid dispensing device 104 can include a pump assembly 300, tubing 402 (e.g., silicone, rubber) itself having a fluid inlet 402a and a fluid outlet 402b, and a fluid source reservoir 408. The fluid dispensing system 400 can also include one or more fluid sensors 410. In some embodiments, the fluid being pumped through the fluid dispensing system 400 only comes in contact with the fluid source reservoir 408 and the tubing 402 and does not make contact with the other components of the system, such as the pump assembly 300 and the robotic arm 404. This helps reduce any cross contamination between fluids. Additionally, as the tubing 402 can be easily removed and/or disposed of, this allows efficient switching out of tubing 402 in the overall system for ease of transitioning between different fluids.

In some embodiments, the fluid dispensing system 400 can be configured to provide a dispensing volume that corresponds to a 360-degree rotation of the pump divided by the number of rollers attached to its rotor. For example, in the case of a peristaltic pump, the dispensing volume may correspond to a rotation of the pump (e.g., equal to a 360-degree rotation) divided by its number of rollers, such as multiples of 90 degrees for a four-roller peristaltic pump. This can allow for an accuracy in the dispensing volume of between approximately 10 to 30 μL (e.g., less than approximately 30 μL), such as when used in combination with tubing having an outer diameter of approximately 0.25 inches. In some embodiments, the fluid dispensing system 400 can provide at least approximately 200 μL of displaced fluid through the tubing for each quarter rotation of the pump.

In some embodiments, the fluid dispensing system 400 can further include one or more fluid sensors 410. The fluid sensor(s) 410 can be configured to detect the presence of any bubbles or airgaps in the tubing, whether the fluid source reservoir (e.g., 408) is empty, whether one or more components of the dispensing device have been improperly primed or have improperly fitted connections, and the like. The one or more fluid sensors 410 can be positioned at one or more points throughout the fluid dispensing system 400, such as at the fluid outlet 402b and/or at a predefined distance upstream of the fluid inlet 402a (e.g., on the fluid source reservoir 408). In some embodiments, the fluid sensor(s) 410 can be used to calculate a flowrate of the fluid flowing through the fluid dispensing device.

In some embodiments, the fluid dispensing system 400 can be configured to operate on a liquid handling deck or robot, for example, via a capacitive sensor. Such integration may provide a benefit of automated use without the need for integrating respective software into the fluid dispensing device. The liquid handling deck may include a robotic arm 404 that may be configured to direct the fluid out of the fluid outlet 402b and into one or more fluid wells 406 based on a respective position (e.g., based X and Y coordinates) of each well. The robotic arm 404 may work in tandem with a reservoir to determine each fluid well's respective position. The reservoir may be a waste reservoir and/or a positioning and priming reservoir. In some embodiments, the robotic arm 404 can move side to side (in the X and Y directions) and/or up and down (in the Z direction) relative to the fluid wells 406 to reduce any cross contamination between individual wells (e.g., due to splashing, aerosolization, etc.) and/or turbulent or viscous forces on the fluid or any structures suspended in the fluid (e.g., cells or beads). Such movement capability of the robotic arm 404 may allow it to deliver liquid to various points in space including, for example, wells of a microplate, test tube, flask, and/or reservoir that can be respectively located on the liquid handling deck and/or at any position within the reach of the robotic arm 404. In some embodiments, the robotic arm 404 can be configured to control a resting or idle position. In some embodiments, the timing and/or positioning of each of the robotic arm's movements, as disclosed herein, can be integrated with dispensing software.

In some embodiments, the fluid dispensing device 400 can further include a waste receptable 412 configured for priming, calibrating, and/or cleaning one or more components of the dispensing device, such as the robotic arm 404, tubing 402, etc. In some embodiments, the fluid dispensing device 400 can further include one or more plate nests 414 that can aid the robotic arm in directing the fluid into the fluid wells, for example, by holding steady a fluid well microplate 416.

In some embodiments, each component of the fluid dispensing devices disclosed herein that come in contact with the fluid can be composed of one or more materials that can be disposed of and/or easily sterilized between uses. This prevents contamination and allows efficient preparation of the devices for use with new fluids without risk of impurities from previous device uses.

In some embodiments, the fluid dispensing device 400 may be connected to an external power source and/or integrated with software.

In some embodiments, the fluid dispensing device 400 may be hooked up to a computer (e.g., computing device 102) via, for example, a Universal Serial Bus (USB) connection, and/or an application programming interface (API) for remote connection. The computer may issue one or more commands to the dispensing device such that it can provide one or more automated functions.

For example, the computer may provide an automated procedure to prevent dripping of any fluid at the terminus or fluid outlet 402b, or at a nozzle. This procedure may involve reversing the direction of the pump 302 to draw a controlled volume of air into the tubing. A fluid sensor (e.g., 410) attached to the tubing can be used to verify the position of the air-liquid interface within the tubing. As another example, the computer may provide an automated procedure for priming the tubing 402 prior to use.

In some embodiments, multiple fluid dispensing devices 104 can be connected to the same computing device 102 and robotic arm 404, which can allow for multiple fluids to be dispensed with volumetric control and without a risk of cross contamination. For example, as particularly shown in FIG. 1, an automated fluid dispensing system 100 can include a computing device 102, a first fluid dispensing device 104a, and a second fluid dispensing device 104b. The first and second fluid dispensing devices 104a, 104b may each include, for example, a fluid source reservoir 408, tubing 402, and a pump assembly 300, as shown in FIG. 4. The computing device 102 can be connected to both the first and second fluid dispensing devices 104a, 104b, and a central robotic arm 404 configured to direct a first fluid from the first fluid dispensing device into one or more first fluid wells, and a second fluid from the second fluid dispensing device into one or more second fluid wells. In some embodiments, the robotic arm may be configured to direct the first and second fluids (from the first and second dispending devices, respectively) into the same or different fluid wells.

### Examples

The fluid dispensing devices disclosed here can be illustrated via the following examples.

### Purpose

An experiment was performed to quantify the volumetric accuracy with which a peristaltic pump could be used to dispense precise volumes of liquid.

### Procedure

A Masterflex L/S pump head (model 77202-60) was mounted to a Prusa i3 extruder stepper motor. A stepper motor driver with an Arduino CT UNO microcontroller was used to control the stepper motor. One quarter inch Masterflex L/S was connected to the peristaltic pump, a bottle of purified water as the source and a small cup as the outlet receptacle. The outlet receptacle was placed on a jewelers scale with a 1 milligram (mg) accuracy. Various numbers of steps corresponding to degrees of rotation of the peristaltic pump rotor were sent to the stepper motor and the weight of the liquid was recorded in milliliters (ml) with an assumed density of 1 g/ml.

### Results

The data indicates that 90 degrees of rotation of the peristaltic pump rotor is the minimum increment size for dispensing repeatability. This means that for a four-rotor peristaltic pump, increments of 90 degrees correspond to a rotor always beginning and ending in the same orientation. Additionally, a 90-degree rotation corresponds to a dispensing increment of approximately 200 μl (0.2 mL) and can be repeatably dispensed to within approximately 10-30 μl accuracy (e.g., less than 30 μl accuracy). This accuracy does not increase with larger multiples of 200 μl indicating that the error is likely dominated by effects at the start and stop of the rotation. The results of such experiments are shown below in Table 1.

TABLE 1

| | Pump Rotation (degrees) | | | | | | |
|---|---|---|---|---|---|---|---|
| | | | | | 90 deg | 15, 360-deg | 15, 360-deg |
| | | | | | without | rotations | rotations |
| | 45 deg | 90 deg | 90 deg | 360 deg | nozzle | with nozzle | without nozzle |
| Displaced | 0.124 | 0.21 | 0.202 | 0.778 | 0.201 | 11.91 | 11.97 |
| fluid | 0.083 | 0.203 | 0.2 | 0.778 | 0.193 | 11.92 | 11.973 |
| volume | 0.122 | 0.202 | 0.2 | 0.792 | 0.201 | 11.92 | 11.979 |
| (mL) | 0.078 | 0.202 | 0.198 | 0.793 | 0.195 | 11.93 | 11.93 |
| | 0.128 | 0.201 | 0.2 | 0.793 | 0.198 | 11.98 | 11.935 |
| | 0.08 | 0.2 | 0.203 | 0.795 | 0.198 | | 11.931 |
| | 0.119 | 0.197 | 0.201 | 0.796 | 0.201 | | 11.938 |
| | 0.05 | 0.2 | | 0.789 | 0.194 | | |
| | | 0.2 | | 0.796 | | | |
| | | | | 0.792 | | | |
| | | | | 0.794 | | | |
| Mean | 0.098 | 0.202 | 0.201 | 0.791 | 0.198 | 11.932 | 11.951 |
| Std Dev | 0.02890 | 0.00357 | 0.00162 | 0.00652 | 0.00329 | 0.02775 | 0.02197 |
| Maximum | 0.128 | 0.21 | 0.203 | 0.796 | 0.201 | 11.98 | 11.979 |
| Minimum | 0.05 | 0.197 | 0.198 | 0.778 | 0.193 | 11.91 | 11.93 |
| Max − Min | 0.078 | 0.013 | 0.005 | 0.018 | 0.008 | 0.07 | 0.049 |

As shown in Table 1, the results of the disclosed experiments show that the pump is capable of consistently displacing approximately 0.2 mL of fluid with each 90-degree rotation, with or without including a nozzle on the fluid outlet. Additionally, an accuracy of between approximately 10-30 μL can be achieved. This accuracy is not reduced by multiple full rotations of the pump. For example, Table 1 shows that 15 full 36-degree rotations of the pump (both with or without an added nozzle at the fluid outlet) do not result in reduced accuracy.

In an example, there are multiple pump assemblies 300, each with their respective tubing 402 and fluid source reservoir 408. A single robotic arm 404 can engage with the individual fluid outlets 402b of the tubing 402. A computing device 102 is in communication with the robotic arm 404 and pump assemblies 300 to direct the location of the individual fluid outlets and to cycle the rotation of one or more pumps 302 to accurately dispense one or more fluids. The robotic arm 404 can be preconfigured with individual dispensing nozzles 418, each connected to an individual fluid outlet 402b, or the robotic arm 404 can engage and disengage with individual nozzles stored separately. The system allows for one fluid per pump/tubing/nozzle combination to effectively reduce or eliminate cross contamination and to allow for ease of cleaning the tubing or swapping out the entire tubing and fluid source reservoir.

In some examples, disclosed systems or methods may involve one or more of the following clauses:

Clause 1: An automated fluid dispensing system comprising: a computing device comprising: one or more processors; and a memory; and a first fluid dispensing device comprising: first tubing comprising a first fluid inlet and a first fluid outlet and configured to make contact with a first fluid running from the first fluid inlet to the first fluid outlet; and a first pump assembly configured to pump the first fluid from the first fluid inlet to the first fluid outlet without making contact with the first fluid, the first pump assembly comprising: a first pump comprising a rotor and a number of rollers attached to the rotor; and a first rotational stepper motor configured to provide power to the first pump; and a robotic arm configured to direct the first fluid out of the first fluid outlet and into one or more fluid wells based on a respective position of each fluid well, wherein the computing device provides one or more commands to the first fluid dispensing device and the robotic arm, and wherein a dispensing volume of the first fluid dispensing device corresponds to a 360-degree rotation of the first pump divided by the number of rollers.

Clause 2: The automated fluid dispensing system of clause 1, wherein the first pump assembly further comprises a stepper motor driver configured to control a rotational distance and a speed of the first rotational stepper motor.

Clause 3: The automated fluid dispensing system of clause 1, wherein the respective position comprises respective X and Y coordinates.

Clause 4: The automated fluid dispensing system of clause 1, further comprising a reservoir.

Clause 5: The automated fluid dispensing system of clause 4, wherein the robotic arm and the reservoir operate in tandem to determine the respective position of each fluid well.

Clause 6: The automated fluid dispensing system of clause 4, wherein the reservoir comprises a waste reservoir.

Clause 7: The automated fluid dispensing system of clause 4, wherein the reservoir comprises a plate positioning and priming reservoir.

Clause 8: The automated fluid dispensing system of clause 1, further comprising: a second fluid dispensing device comprising: second tubing comprising a second fluid inlet and a second fluid outlet and configured to make contact with a second fluid running from the second fluid inlet to the second fluid outlet; and a second pump assembly configured to pump the second fluid from the second fluid inlet to the second fluid outlet without making contact with the second fluid, wherein the robotic arm is configured to direct the second fluid out of the second fluid outlet and into the one or more fluid wells based on the respective position of each fluid well, and wherein the computing device provides one or more second commands to the second fluid dispensing device.

Clause 9: The automated fluid dispensing system of clause 1, wherein the first fluid dispensing device provides at least approximately 200 microliter (μL) of displaced fluid through the first tubing for each quarter rotation of the first pump.

Clause 10: The automated fluid dispensing system of clause 1, wherein the first fluid dispensing device provides an accuracy of the dispensing volume of less than approximately 30 μL.

Clause 11: The automated fluid dispensing system of clause 10, wherein the first tubing comprises an outer diameter of approximately 0.25 inches.

Clause 12: The automated fluid dispensing system of clause 1, wherein the automated fluid dispensing system is configured to automatically prime the first tubing.

Clause 13: The automated fluid dispensing system of clause 1, further comprising one or more fluid sensors.

Clause 14: The automated fluid dispensing system of clause 13, wherein the one or more fluid sensors are configured to detect one or more of bubbles in the first tubing, airgaps in the first tubing, an empty fluid source reservoir, tubing damage, improperly primed tubing, improperly fitted connections, or combinations thereof.

Clause 15: The automated fluid dispensing system of clause 13, wherein a first fluid sensor of the one or more fluid sensors is positioned at the first fluid outlet, wherein a second fluid sensor of the one or more fluid sensors is positioned at a set distance before the first fluid inlet, and wherein the first and second fluid sensors are configured to detect a first fluid flowrate.

Clause 16: The automated fluid dispensing system of clause 1, wherein the automated fluid dispensing system is configured to automatically prevent dripping of the first fluid at the first fluid outlet.

Clause 17: The automated fluid dispensing system of clause 1, wherein the one or more fluid wells are located in one or more of a microplate, a test tube, a flask, a reservoir, or combinations thereof.

Clause 18: The automated fluid dispensing system of clause 1, wherein the robotic arm operates in an upward and a downward direction relative to the one or more fluid wells to reduce a risk of cross contamination.

Clause 19: The automated fluid dispensing system of clause 1, wherein the first pump comprises one or more of a positive displacement pump, a centrifugal pump, an axial-flow pump, a peristaltic pump, or combinations thereof.

Clause 20: The automated fluid dispensing system of clause 1, wherein the first pump assembly further comprises one or more of a microcontroller, a stepper motor driver, an input/output device, or combinations thereof.

Clause 21: The automated fluid dispensing system of clause 1, further comprising: a waste receptable configured for one or more of priming, calibration, cleaning, or combinations thereof.

Clause 22: The automated fluid dispensing system of clause 1, further comprising: one or more plate nests configured to aid the robotic arm in directing the first fluid into the one or more fluid wells.

Clause 23: An automated fluid dispensing system comprising: a computing device comprising: one or more processors; and a memory; a first fluid dispensing device comprising: first tubing comprising a first fluid inlet and a first fluid outlet and configured to make contact with a first fluid running from the first fluid inlet to the first fluid outlet; and a first pump assembly configured to pump the first fluid from the first fluid inlet to the first fluid outlet and comprising: a first peristaltic pump; and a first rotational stepper motor configured to provide power to the first peristaltic pump; and a robotic arm configured to direct the first fluid out of the first fluid outlet and into one or more fluid wells based on a respective position of each fluid well, wherein the computing device provides one or more commands to the first fluid dispensing device and the robotic arm, and wherein the first fluid dispensing device provides at least approximately 200 microliters (μL) of displaced fluid through the first tubing for each quarter rotation of the first peristaltic pump.

Clause 24: The automated fluid dispensing system of clause 23, wherein the first fluid dispensing device provides an accuracy of a dispensing volume of less than approximately 30 μL.

Clause 25: An automated fluid dispensing system comprising: a computing device comprising: one or more processors; and a memory; a first fluid dispensing device comprising: first tubing comprising a first fluid inlet and a first fluid outlet and configured to make contact with a first fluid running from the first fluid inlet to the first fluid outlet; and a first pump assembly configured to pump the first fluid from the first fluid inlet to the first fluid outlet without making contact with the first fluid, the first pump assembly comprising: a first pump; and a first rotational stepper motor configured to provide power to the first pump; a second fluid dispensing device comprising: second tubing comprising a second fluid inlet and a second fluid outlet and configured to make contact with a second fluid running from the second fluid inlet to the second fluid outlet; and a second pump assembly configured to pump the second fluid from the second fluid inlet to the second fluid outlet without making contact with the second fluid, the second pump assembly comprising: a second pump; and a second rotational stepper motor configured to provide power to the second pump; and a robotic arm configured to direct (i) the first fluid out of the first fluid outlet and into one or more first fluid wells based on a first respective position of each first fluid well, and (ii) the second fluid out of the second fluid outlet and into one or more second fluid wells based on a second respective position of each second fluid well, wherein the computing device provides one or more commands to the first pump assembly, the second pump assembly, and the robotic arm, wherein the automated fluid dispensing system provides at least approximately 200 microliters (μL) of displaced fluid through the first tubing for each quarter rotation of the first pump, and wherein the automated fluid dispensing system provides at least approximately 200 microliters (μL) of displaced fluid through the second tubing for each quarter rotation of the second pump.

The design and functionality described in this application is intended to be exemplary in nature and is not intended to limit the instant disclosure in any way. Those having ordinary skill in the art will appreciate that the teachings of the disclosure may be implemented in a variety of suitable forms, including those forms disclosed herein and additional forms known to those having ordinary skill in the art. This disclosure is intended to cover various modifications and equivalent arrangements included within the scope of the appended claims. Although specific terms are employed herein, they are used in a generic and descriptive sense only and not for purposes of limitation.

It must also be noted that, as used in the specification and the appended claims, the singular forms “a,” “an” and “the” include plural referents unless the context clearly dictates otherwise.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

Dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical range and sub-range is explicitly recited. For example, a range of approximately 1 to 99.99 should be interpreted to include not only the explicitly recited limits of approximately 1 and approximately 99.99, but also individual amounts such as 2, 3, 4, 5.01, 5.02, 26, 67.1, 99.98, etc., and sub ranges such as 5 to 80 and 30.21 to 83.24, etc. Similarly, it should be understood that when numerical ranges are provided, such ranges are to be construed as providing literal support for claim limitations that only recite the lower value of the range as well as claim limitations that only recite the upper value of the range. For example, a disclosed numerical range of 5 to 15 provides literal support for a claim reciting “greater than 5” (with no upper bounds) and a claim reciting “less than 15” (with no lower bounds).

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An automated fluid dispensing system comprising:
a computing device comprising:
one or more processors; and
a memory; and
a first fluid dispensing device comprising:
first tubing comprising a first fluid inlet and a first fluid outlet and configured to make contact with a first fluid running from the first fluid inlet to the first fluid outlet; and
a first pump assembly configured to pump the first fluid from the first fluid inlet to the first fluid outlet without making contact with the first fluid, the first pump assembly comprising:
a first pump comprising a rotor and a number of rollers attached to the rotor; and
a first rotational stepper motor configured to provide power to the first pump; and
a robotic arm configured to direct the first fluid out of the first fluid outlet and into one or more fluid wells based on a respective position of each fluid well,
wherein the computing device provides one or more commands to the first fluid dispensing device and the robotic arm, and
wherein a dispensing volume of the first fluid dispensing device corresponds to a 360-degree rotation of the first pump divided by the number of rollers.

2. The automated fluid dispensing system of claim 1, wherein the first pump assembly further comprises a stepper motor driver configured to control a rotational distance and a speed of the first rotational stepper motor.

3. The automated fluid dispensing system of claim 1, wherein the respective position comprises respective X and Y coordinates.

4. The automated fluid dispensing system of claim 1, further comprising a reservoir,
wherein the robotic arm and the reservoir operate in tandem to determine the respective position of each fluid well, and wherein the reservoir comprises a waste reservoir, a plate positioning and priming reservoir, or both.

5. The automated fluid dispensing system of claim 1, further comprising:
a second fluid dispensing device comprising:
second tubing comprising a second fluid inlet and a second fluid outlet and configured to make contact with a second fluid running from the second fluid inlet to the second fluid outlet; and
a second pump assembly configured to pump the second fluid from the second fluid inlet to the second fluid outlet without making contact with the second fluid,
wherein the robotic arm is configured to direct the second fluid out of the second fluid outlet and into the one or more fluid wells based on the respective position of each fluid well, and
wherein the computing device provides one or more second commands to the second fluid dispensing device.

6. The automated fluid dispensing system of claim 1, wherein the first fluid dispensing device provides at least approximately 200 microliter (μL) of displaced fluid through the first tubing for each quarter rotation of the first pump.

7. The automated fluid dispensing system of claim 1, wherein the first fluid dispensing device provides an accuracy of the dispensing volume of less than approximately 30 μL.

8. The automated fluid dispensing system of claim 7, wherein the first tubing comprises an outer diameter of approximately 0.25 inches.

9. The automated fluid dispensing system of claim 1, wherein the automated fluid dispensing system is configured to automatically prime the first tubing.

10. The automated fluid dispensing system of claim 1, further comprising one or more fluid sensors, wherein the one or more fluid sensors are configured to detect one or more of bubbles in the first tubing, airgaps in the first tubing, an empty fluid source reservoir, tubing damage, improperly primed tubing, improperly fitted connections, or combinations thereof.

11. The automated fluid dispensing system of claim 1, further comprising one or more fluid sensors, wherein a first fluid sensor of the one or more fluid sensors is positioned at the first fluid outlet, wherein a second fluid sensor of the one or more fluid sensors is positioned at a set distance before the first fluid inlet, and wherein the first and second fluid sensors are configured to detect a first fluid flowrate.

12. The automated fluid dispensing system of claim 1, wherein the automated fluid dispensing system is configured to automatically prevent dripping of the first fluid at the first fluid outlet.

13. The automated fluid dispensing system of claim 1, wherein the one or more fluid wells are located in one or more of a microplate, a test tube, a flask, a reservoir, or combinations thereof.

14. The automated fluid dispensing system of claim 1, wherein the robotic arm operates in an upward and a downward direction relative to the one or more fluid wells to reduce a risk of cross contamination.

15. The automated fluid dispensing system of claim 1, wherein the first pump comprises one or more of a positive displacement pump, a centrifugal pump, an axial-flow pump, a peristaltic pump, or combinations thereof.

16. The automated fluid dispensing system of claim 1, wherein the first pump assembly further comprises one or more of a microcontroller, a stepper motor driver, an input/output device, or combinations thereof.

17. The automated fluid dispensing system of claim 1, further comprising:
a waste receptable configured for one or more of priming, calibration, cleaning, or combinations thereof.

18. The automated fluid dispensing system of claim 1, further comprising:
one or more plate nests configured to aid the robotic arm in directing the first fluid into the one or more fluid wells.

19. An automated fluid dispensing system comprising:
a computing device comprising:
one or more processors; and
a memory;
a first fluid dispensing device comprising:
first tubing comprising a first fluid inlet and a first fluid outlet and configured to make contact with a first fluid running from the first fluid inlet to the first fluid outlet; and
a first pump assembly configured to pump the first fluid from the first fluid inlet to the first fluid outlet and comprising:
a first peristaltic pump; and
a first rotational stepper motor configured to provide power to the first peristaltic pump; and
a robotic arm configured to direct the first fluid out of the first fluid outlet and into one or more fluid wells based on a respective position of each fluid well,
wherein the computing device provides one or more commands to the first fluid dispensing device and the robotic arm, and
wherein the first fluid dispensing device provides at least approximately 200 microliters (μL) of displaced fluid through the first tubing for each quarter rotation of the first peristaltic pump.

20. An automated fluid dispensing system comprising:
a computing device comprising:
one or more processors; and
a memory;
a first fluid dispensing device comprising:
first tubing comprising a first fluid inlet and a first fluid outlet and configured to make contact with a first fluid running from the first fluid inlet to the first fluid outlet; and
a first pump assembly configured to pump the first fluid from the first fluid inlet to the first fluid outlet without making contact with the first fluid, the first pump assembly comprising:
a first pump; and
a first rotational stepper motor configured to provide power to the first pump;
a second fluid dispensing device comprising:
second tubing comprising a second fluid inlet and a second fluid outlet and configured to make contact with a second fluid running from the second fluid inlet to the second fluid outlet; and
a second pump assembly configured to pump the second fluid from the second fluid inlet to the second fluid outlet without making contact with the second fluid, the second pump assembly comprising:
a second pump; and
a second rotational stepper motor configured to provide power to the second pump; and
a robotic arm configured to direct (i) the first fluid out of the first fluid outlet and into one or more first fluid wells based on a first respective position of each first fluid well, and (ii) the second fluid out of the second fluid outlet and into one or more second fluid wells based on a second respective position of each second fluid well,
wherein the computing device provides one or more commands to the first pump assembly, the second pump assembly, and the robotic arm,
wherein the automated fluid dispensing system provides at least approximately 200 microliters (μL) of displaced fluid through the first tubing for each quarter rotation of the first pump, and
wherein the automated fluid dispensing system provides at least approximately 200 microliters (μL) of displaced fluid through the second tubing for each quarter rotation of the second pump.
